(19) United States
(12) Patent Application Publication
(10) Pub. No.: US 2026/0211473 A1
(43) Pub. Date: Jul. 23, 2026

(54) INFORMATION PROCESSING APPARATUS

(71) Applicant: Lenovo Japan LLC, Tokyo (JP)

(72) Inventors: Taiki Koide, Kanagawa (JP); Atsunobu Nakamura, Kanagawa (JP); Hiroki Oda, Kanagawa (JP)

(73) Assignee: Lenovo Japan LLC, Tokyo (JP)

(21) Appl. No.: 19/422,061

(22) Filed: Dec. 16, 2025

(30) Foreign Application Priority Data
Jan. 22, 2025 (JP) 2025-009024

(51) Int. Cl. G06F 1/20; G06F 3/023

(52) U.S. Cl. CPC G06F 1/206; G06F 3/0238

(57) ABSTRACT

An information processing apparatus includes: a processor configured to execute a first process by an operating system (OS) and a second process by a program that is executed on the OS. The processor is configured to perform: a first setting control process of selectably controlling an option of a first setting group including options of a plurality of first settings as settings of the OS in the first process; a second setting control process of selectably controlling an option of a second setting group including as options second settings respectively associated with the plurality of first settings included in the first setting group in the second process; and an operation setting process of performing a setting for an operation of the information processing apparatus based on a second setting selected by the second setting control process in the second process.

### CROSS-REFERENCE TO RELATED APPLICATIONS

This application claims priority to Japanese Patent Application No. 2025-009024 filed on January 22, 2025, the contents of which are hereby incorporated herein by reference in their entirety.

### Technical Field

The present invention relates to an information processing apparatus and a control method.

### Background

For the sake of optimization of performance and power consumption, an information processing apparatus such as a laptop PC (personal computer) may have power supply modes (power modes) such as a performance mode that operates with priority on performance, a power-saving mode that operates with priority on power consumption, and a balance mode that operates by balancing the performance and power consumption. Moreover, because an electronic device such as a central processing unit (CPU) generates heat along with operations to cause the temperature rise, a typical information processing apparatus includes a fan for heat dissipation (cooling fan) in order to suppress the temperature rise of a chassis (e.g., see Japanese Unexamined Patent Application Publication No. 2007-226617). The information processing apparatus performs the control of the power supply mode, the control of the fan for heat dissipation, etc. as described above to perform the control (so-called "thermal control") such as the optimization of the performance and power consumption and the suppression of the temperature rise.

For example, although the information processing apparatus has the above-described power supply mode as the setting of an operating system (OS), so as to enable more optimal control in addition to this, a vendor may uniquely provide a thermal control function that can be executed on the OS. For example, as the thermal control function, the information processing apparatus has various modes (hereinafter, referred to as "thermal mode") related to the settings of the performance, the power consumption, the fan for heat dissipation, etc., similar to the setting of the power supply mode provided by the OS.

Herein, when a user selects the above-described thermal mode, it cannot be said that operability is good because multiple (e.g., about four times) operations (e.g., operations when selecting the power supply mode) including an operation on a battery icon of a task bar of a desktop screen are required, in the case of Windows (registered trademark), for example. In this case, the improved operability is anticipated if the selection operation of the thermal mode can be directly performed by using a hot key, etc., for example.

However, any of specific applications or tools that are executed on Windows (registered trademark), for example, may dogmatically change a power plan for Windows (registered trademark). The power plan includes plans for hardware and system settings of managing how power is used, and a power plan (e.g., Balanced) of keeping balance between the performance and power consumption among the plans is set as a standard. In the standard setting, the change in the power supply mode (power mode) as described above can be made, but, if the mode is changed from the standard power plan, the power supply mode may not be changed depending on the content of the changed hardware and system settings. For that reason, when the above-described thermal mode is controlled in correspondence with at least a part of the power supply mode, the thermal mode may not be also changed if the mode is changed from the standard power plan, and thus an operation of using a hot key does not work even if the operation is performed.

### Summary

One or more embodiments of the present invention provide an information processing apparatus and a control method, which can improve operability.

An information processing apparatus according to one or more embodiments of the present invention includes a processor configured to execute a first process by an operating system (OS) and a second process by a program that is executed on the OS, the processor is configured to perform: a first setting control process of selectably controlling an option of a first setting group including options of a plurality of first settings as settings of the OS in the first process; a second setting control process of selectably controlling an option of a second setting group including second settings, as options, respectively associated with each of the plurality of first settings included in the first setting group in the second process; and an operation setting process of performing a setting for an operation of the information processing apparatus based on a second setting selected by the second setting control process in the second process, and the processor is configured to: when the first setting control process is valid, in the second setting control process, acquire a first setting selected from the first setting group by the first setting control process in response to input of a specific operation and select a second setting associated with the acquired first setting from the second setting group; and when the first setting control process is invalid, in the second setting control process, select a second setting from the second setting group in response to the input of the specific operation.

In the information processing apparatus, the processor may be configured to instruct, in the second process, a display unit to display a piece of display information corresponding to the second setting selected by the second setting control process.

In the information processing apparatus, the first settings included in the first setting group and the second settings included in the second setting group may include settings that affect performance and power consumption.

In the information processing apparatus, the second settings included in the second setting group may include a setting that affects a temperature rise inside a chassis of the information processing apparatus.

The information processing apparatus may further include a heat dissipation fan configured to dissipate heat inside the chassis of the information processing apparatus to an outside, and the second settings included in the second setting group may include a setting for control of the heat dissipation fan.

In the information processing apparatus, whether the first setting control process is valid or invalid may be determined based on selection of a setting different from selection of the first setting included in the first setting group among the settings of the OS.

In the information processing apparatus, whether the first setting control process is valid or invalid may be determined based on selection of hardware and system settings related to power among the settings of the OS.

In the information processing apparatus, the specific operation may include a preset operation on a hot key.

In the information processing apparatus, when the first setting control process is invalid, in the second setting control process, the processor may select the second setting directly from the second setting group, without acquiring a first setting selected from the first setting group, in response to the input of the specific operation.

Moreover, an information processing apparatus according to one or more embodiments of the present invention includes a processor configured to execute a first process by an operating system (OS) and a second process by a program that is executed on the OS, the processor is configured to perform: a first setting control process of selectably controlling an option of a first setting group including options of a plurality of first settings as settings of the OS in the first process; a second setting control process of selectably controlling an option of a second setting group including second settings, as options, respectively associated with each of the plurality of first settings included in the first setting group in the second process; and an operation setting process of performing a setting for an operation of the information processing apparatus based on a second setting selected by the second setting control process in the second process, and the processor is configured to switch, in the second setting control process, between a first selection process and a second selection process in accordance with a specific setting different from the first setting among the settings of the OS, the first selection process of acquiring a first setting selected from the first setting group by the first setting control process in response to input of a specific operation and selecting a second setting associated with the acquired first setting from the second setting group, the second selection process of selecting a second setting from the second setting group in response to the input of the specific operation.

Moreover, an information processing apparatus according to one or more embodiments of the present invention includes a processor configured to execute a first process by an operating system (OS) and a second process by a program that is executed on the OS, the processor is configured to perform: a first setting control process of selectably controlling an option of a first setting group including options of a plurality of first settings as settings of the OS in the first process; a second setting control process of selectably controlling an option of a second setting group including second settings, as options, respectively associated with each of the plurality of first settings included in the first setting group in the second process; and an operation setting process of performing a setting for an operation of the information processing apparatus based on a second setting selected by the second setting control process in the second process, and the processor is configured to select a second setting from the second setting group in response to input of a specific operation regardless of the first setting control process in the second setting control process.

One or more of the above-described aspects of present invention can improve the operability of the information processing apparatus.

### BRIEF DESCRIPTION OF THE DRAWINGS

FIG. 1 is a perspective diagram illustrating an appearance of an information processing apparatus according to one or more embodiments;

FIG. 2 is a plan view schematically illustrating an inside of an apparatus chassis of the information processing apparatus according to one or more embodiments;

FIG. 3 is a block diagram illustrating a hardware configuration example of the information processing apparatus according to one or more embodiments;

FIG. 4 is a block diagram illustrating a functional configuration example of the information processing apparatus according to one or more embodiments;

FIG. 5 is an explanatory diagram illustrating an overview of the selection of a thermal mode according to one or more embodiments;

FIGS. 6A-6B are diagrams illustrating an example of a relationship between a power plan and a power supply mode (power mode) according to one or more embodiments; and

FIG. 7 is a diagram illustrating an example of a flow of a selection process of the thermal mode according to one or more embodiments.

### DETAILED DESCRIPTION

Hereinafter, embodiments of the present invention will be described in detail with reference to the accompanying drawings.

### Overview of Information processing apparatus

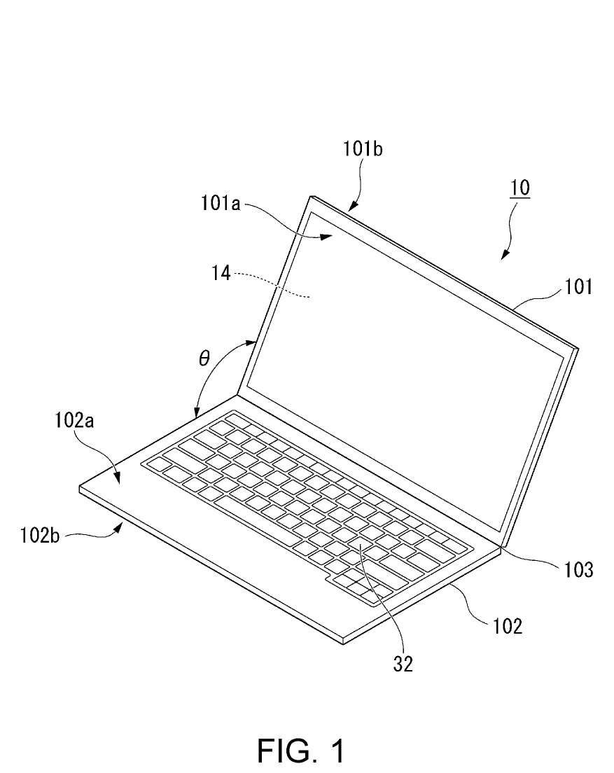

First, the overview of an information processing apparatus according to one or more embodiments will be described. FIG. 1 is a perspective diagram illustrating an appearance of an information processing apparatus 10 according to one or more embodiments. The information processing apparatus 10 illustrated in FIG. 1 is a clamshell laptop personal computer (PC). The information processing apparatus 10 includes a display chassis 101 mounted with a display unit 14 (display), an apparatus chassis 102 mounted with a keyboard 32, and a hinge mechanism 103. The display chassis 101 and the apparatus chassis 102 are a substantially quadrangular plate-shaped (e.g., tabular) chassis. One of side surfaces of the display chassis 101 and one of side surfaces of the apparatus chassis 102 are joined (connected) via the hinge mechanism 103, and the display chassis 101 and the apparatus chassis 102 are relatively rotatable around a rotation axis defined by the hinge mechanism 103. A state in which an opening angle 8 around the rotation axis between the display chassis 101 and the apparatus chassis 102 is substantially 0° is a state (hereinafter, referred to as "closed state") in which the display chassis 101 and the apparatus chassis 102 overlap each other and are closed. A state in which the display chassis 101 and the apparatus chassis 102 are open relative to the closed state is referred to as an "open state". The open state is a state in which the display chassis 101 and the apparatus chassis 102 are relatively rotated until the opening angle 8 becomes larger than a preset threshold (e.g., 10°).

A surface on which the display unit 14 of the display chassis 101 is provided is referred to as a display surface 101a, and a surface opposite to the display surface 101a is referred to as a top surface 101b. Moreover, a surface on which the keyboard 32 of the apparatus chassis 102 is provided is referred to as a keyboard surface 102a, and a surface opposite to the keyboard surface 102a is referred to as a bottom surface 102b. In the closed state, the display surface 101a and the keyboard surface 102a are surfaces that face each other. In the illustrated example, the keyboard 32 is a physical keyboard on which a plurality of keys (example of operators) accepting an operation of a user are arrayed. Note that the keyboard surface 102a may be provided with a touch pad etc. other than the keyboard 32.

In the closed state, because the display surface 101a of the display chassis 101 and the keyboard surface 102a of the apparatus chassis 102 overlap each other, the display unit 14 cannot be visually recognized and the keyboard 32 cannot be operated. On the other hand, in the open state, the display unit 14 can be visually recognized and the keyboard can be operated.

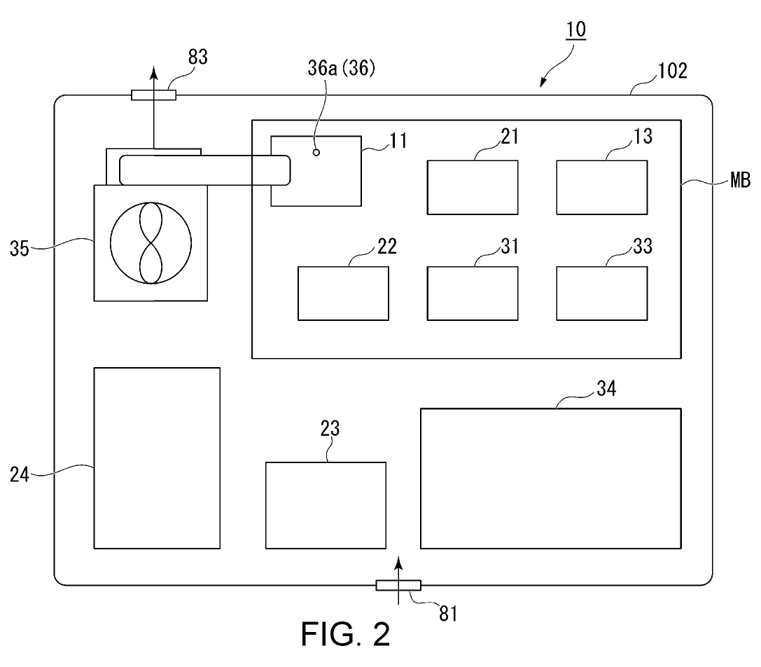

FIG. 2 is a plan view schematically illustrating an inside of the apparatus chassis 102 of the information processing apparatus 10. A motherboard MB, a storage medium 23, an audio system 24, a battery 34, and a heat dissipation fan 35 are arranged inside the apparatus chassis 102. The motherboard MB is mounted with, for example, a central processing unit (CPU) 11, a video subsystem 13, a chipset 21, a basic input/output system (BIOS) memory 22, an embedded controller 31, a power supply circuit 33, and the like.

The CPU 11 may be a CPU and a graphics processing unit (GPU) or one of them. The CPU 11 may be of a type in which the CPU and the GPU are formed on the same core. Furthermore, the CPU 11 may be of a type in which the CPU and the GPU are formed on separate cores to divide a load. Moreover, the CPU 11 may include two or more CPUs. The CPU 11 generates more heat as an operating frequency, power consumption, and the like are higher to lead to the temperature rise inside the apparatus chassis 102. Note that another electronic device inside the apparatus chassis 102 may also be a source of heat.

The heat dissipation fan 35 (example of heat dissipation unit) interchanges air inside the apparatus chassis 102 with outside air. For example, when the heat dissipation fan 35 is activated to rotate a fan (impeller), the outside air enters the apparatus chassis 102 through an inlet 81 of the apparatus chassis 102, exchanges heat with a heatsink (not illustrated), and is discharged outside of the apparatus chassis 102 from an outlet 83. The heatsink is thermally coupled to the CPU 11 by a heat pipe (not illustrated) etc. The electronic devices requiring temperature management and temperature sensors 36 at a plurality of predetermined positions in the apparatus chassis 102 are arranged in the apparatus chassis 102. For example, an illustrated temperature sensor 36a among the temperature sensors is arranged to detect the temperature of the CPU 11. The other temperature sensors 36 not illustrated are similarly arranged to detect the temperatures at the respective positions. The information processing apparatus 10 can dissipate the heat inside the apparatus chassis 102 by rotating the heat dissipation fan 35 based on the detected temperatures of the temperature sensors 36.

### Hardware configuration of Information processing apparatus 10

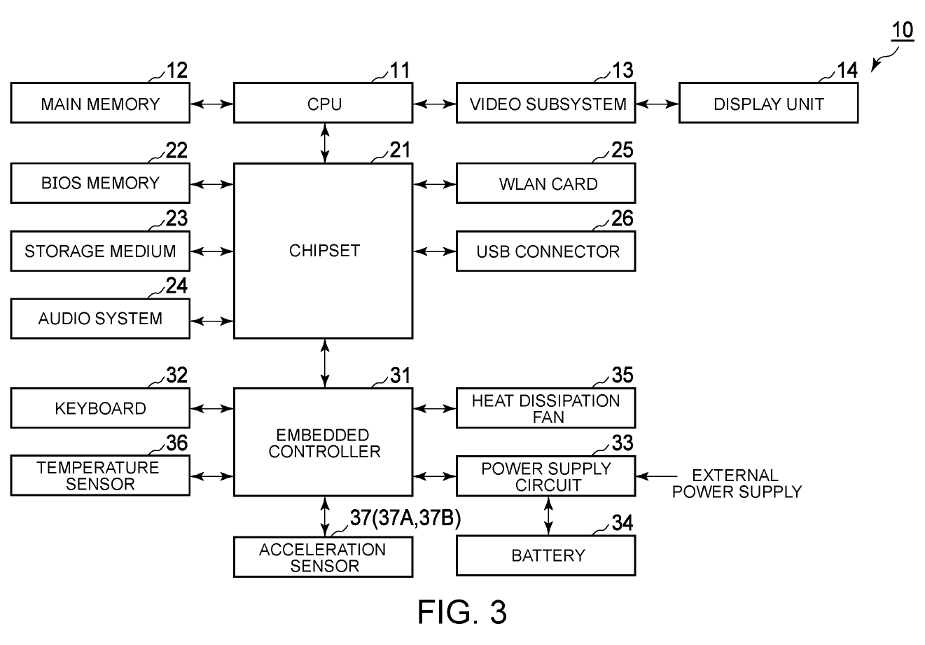

Next, the main hardware configuration of the information processing apparatus 10 will be described with reference to FIG. 3. FIG. 3 is a block diagram illustrating a hardware configuration example of the information processing apparatus 10.

The information processing apparatus 10 includes the CPU 11, a main memory 12, the video subsystem 13, the display unit 14, the chipset 21, the BIOS memory 22, the storage medium 23, the audio system 24, a WLAN card 25, a USB connector 26, the embedded controller 31, the keyboard 32, the power supply circuit 33, the battery 34, the heat dissipation fan 35, the temperature sensors 36, and an acceleration sensor 37.

The CPU 11 executes various arithmetic processes by program control to control the entire of the information processing apparatus 10. For example, the CPU 11 executes the processes based on programs of an operating system (OS) and BIOS. The main memory 12 is a writable memory that is used as a reading area of execution programs of the CPU 11 or a working area for writing processing data of the execution programs. The main memory 12 is composed of a plurality of dynamic random access memory (DRAM) chips, for example. The execution programs include the OS, various drivers for operating peripheral devices by hardware, various services/utilities, application programs, and the like.

The video subsystem 13 is a subsystem for realizing functions associated with image display, and includes a video controller. The video controller processes drawing commands from the CPU 11, and writes the processed drawing information to a video memory and reads the drawing information from the video memory to output the information to the display unit 14 as drawing data (display data).

The display unit 14 is a liquid crystal display or an organic electroluminescence display, for example, and displays a display screen based on the drawing data (display data) output from the video subsystem 13.

The chipset 21 includes controllers for a universal serial bus (USB), a serial ATA (AT Attachment), a serial peripheral interface (SPI) bus, a peripheral component interconnect (PCI) bus, a PCI-Express bus, a low pin count (LPC) bus, and the like to connect the plurality of devices. For example, the plurality of devices include the BIOS memory 22, the storage medium 23, the audio system 24, the WLAN card 25, the USB connector 26, and the embedded controller 31 to be described later.

The BIOS memory 22 is composed of an electrically rewritable nonvolatile memory such as an electrically erasable programmable read only memory (EEPROM) and a flash ROM. The BIOS memory 22 stores therein system firmware etc. for controlling the BIOS, the embedded controller 31, and the like.

The storage medium 23 is configured to include a hard disk drive (HDD), a solid state drive (SSD), and the like. For example, the storage medium 23 stores therein the OS, various drivers, various services/utilities, application programs, and various data.

The audio system 24 is connected to a microphone and a speaker, which are not illustrated, to record, play, and output sound data. Note that the microphone and the speaker are embedded in the information processing apparatus 10 as an example.

The wireless local area network (WLAN) card 25 is connected to the network by a wireless (radio) LAN to perform data communication. When receiving data from the network, for example, the WLAN card 25 generates an event trigger indicating the reception of data. The USB connector 26 is a connector for connecting the peripheral devices of using the USB.

The keyboard 32 is an input device on which the plurality of keys (example of operators) accepting an operation of the user are arrayed. As illustrated in FIG. 1, the keyboard 32 is provided on the keyboard surface 102a of the apparatus chassis 102. The keyboard 32 outputs to the embedded controller 31 input information (e.g., an operation signal indicating a key operated on the keyboard) input by the operation of the user.

The power supply circuit 33 is configured to include a DC/DC converter, a charge/discharge unit, an AC/DC adapter, and the like, for example. For example, the power supply circuit 33 converts a DC voltage supplied from the battery 34 or an external power supply such as an AC adapter (not illustrated) into a plurality of voltages required to operate the information processing apparatus 10. Moreover, based on the control from the embedded controller 31, the power supply circuit 33 supplies power to the components of the information processing apparatus 10.

The battery 34 is a lithium battery, for example, and is charged via the power supply circuit 33 when the power is supplied to the information processing apparatus 10 from the external power supply and outputs the charged power via the power supply circuit 33 as the operating power of the information processing apparatus 10 when the power is not supplied to the information processing apparatus 10 from the external power supply.

The acceleration sensor 37 includes an acceleration sensor 37A provided inside the display chassis 101 and an acceleration sensor 37B provided inside the apparatus chassis 102. The information processing apparatus 10 uses the detection results of the two acceleration sensors 37 (37A and 37B) to detect the opening angle 8 between the display chassis 101 and the apparatus chassis 102. For example, based on a detection signal output from the acceleration sensor 37A and a detection signal output from the acceleration sensor 37B, the information processing apparatus 10 can estimate orientations (postures) of the display chassis 101 and the apparatus chassis 102 to detect the opening angle ϴ.

The embedded controller 31 is a one-chip microcomputer that monitors and controls various devices (peripheral devices, sensors, etc.) regardless of the state of the system of the information processing apparatus 10. The embedded controller 31 includes a CPU, a ROM, a RAM, a multi-channel A/D input terminal, a D/A output terminal, a timer, and a digital input/output terminal that are not illustrated. The digital input/output terminal of the embedded controller 31 is connected to the keyboard 32, the power supply circuit 33, the heat dissipation fan 35, the temperature sensors 36, the acceleration sensor 37, and the like, for example. The embedded controller 31 receives input information (operation signal) from the keyboard 32 and sensor signals from the temperature sensors 36, the acceleration sensor 37, etc. Moreover, the embedded controller 31 controls operations of the power supply circuit 33, the heat dissipation fan 35, etc.

### Functional configuration of Information processing apparatus 10

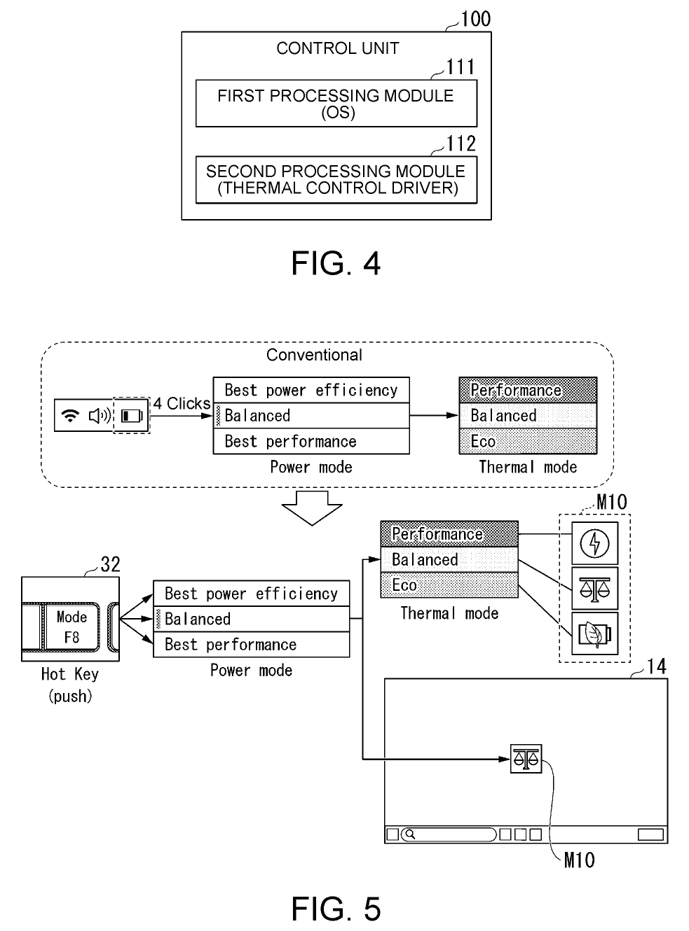

FIG. 4 is a block diagram illustrating a functional configuration example of the information processing apparatus 10 according to one or more embodiments. The information processing apparatus 10 includes a control unit 100 as a functional configuration. The control unit 100 includes a first processing module 111 as a functional configuration realized by the CPU 11 by executing programs of the OS. Moreover, the control unit 100 includes a second processing module 112 as a functional configuration realized by the CPU 11 by executing a program of a thermal control driver on the OS.

The first processing module 111 executes various types of processes by the OS. For example, the first processing module 111 selectably controls an option of a plurality of modes included in a power supply mode (power mode). Herein, the plurality of modes included in the power supply mode include, as settings of the OS, settings that affect performance and power consumption, for example.

The second processing module 112 executes a process by the thermal control driver that is executed on the OS. For example, the second processing module 112 selectably controls an option of a plurality of modes included in a thermal mode. Herein, the plurality of modes included in the thermal mode are thermal control functions, which are uniquely provided by a vendor etc. separately from the OS settings and can be executed on the OS, and include, for example, settings etc. that affect the performance, the power consumption, and the temperature rise of the chassis inside (mainly, the inside of the apparatus chassis 102).

Based on a mode selected from among the plurality of modes included in the thermal mode, the second processing module 112 performs a setting for an operation of the information processing apparatus 10. For example, settings for the limitation of an operating frequency of the CPU 11, a screen brightness of the display unit 14, a rotation speed of the heat dissipation fan 35, and the like are performed.

Herein, a relationship between the selection of the thermal mode in the thermal control function and the power supply mode (power mode) by the OS will be described with reference to FIG. 5.

FIG. 5 is an explanatory diagram illustrating an overview of the selection of the thermal mode according to one or more embodiments. In the illustrated example, the thermal mode includes options of a performance mode (Performance) corresponding to a setting that operates with priority on performance, a power-saving mode (Eco) corresponding to a setting that operates with priority on power consumption, and a balance mode (Balanced) corresponding to a setting that operates by balancing the performance and power consumption.

For example, in the example of Windows (registered trademark), the power supply mode (power mode) includes options of a best performance mode (Best performance) corresponding to a setting that operates with priority on performance, a power efficiency mode (Best power efficiency) corresponding to a setting that operates with priority on power efficiency, and a balance mode (Balanced) corresponding to a setting that operates by balancing the performance and power efficiency.

The conventional method has an operating specification that the user selects the power supply mode (power mode) by performing four operations (4 Clicks) including the operation on the battery icon of the task bar of the desktop screen, for example. Moreover, the options of the thermal mode are associated with the options of the power supply mode (power mode) of the OS, and when the option of the power supply mode (power mode) is selected by the user performing four operations (4 Clicks), an operating specification is taken that an option of the thermal mode associated with the selected option of the power supply mode (power mode) is selected. As described above, conventionally, the selection of the thermal mode requires to perform multiple operations (e.g., four operations) and thus it cannot be said that operability is good.

Therefore, in one or more embodiments, four operations beginning with an operation on the conventional task bar are changed to a preset operation (e.g., fn+F8 key) on a hot key among the keys arrayed on the keyboard 32. As a result, the options of the thermal mode are sequentially selected in a toggle manner in response to the pressing of the hot key to improve the operability. Hereinafter, the selection of the thermal mode according to one or more embodiments will be specifically explained.

Specifically, because the options of the thermal mode are associated with the options of the power supply mode (power mode) of the OS, when an option of the power supply mode (power mode) of the OS is selected in response to the pressing of the hot key, an option of the thermal mode associated with the selected option of the power supply mode (power mode) is selected consequently.

For example, the performance mode (Performance) of the thermal mode is associated with the best performance mode (Best performance) of the power supply mode (power mode). The power-saving mode (Eco) of the thermal mode is associated with the power efficiency mode (Best power efficiency) of the power supply mode (power mode). The balance mode (Balanced) of the thermal mode is associated with the balance mode (Balanced) of the power supply mode (power mode).

When the hot key is pressed once, the performance mode (Performance) of the thermal mode is selected by selecting the best performance mode (Best performance) of the power supply mode (power mode), for example. When the hot key is further pressed once, the balance mode (Balanced) of the thermal mode is selected by selecting the balance mode (Balanced) of the power supply mode (power mode). Moreover, when the hot key is further pressed once, the power-saving mode (Eco) of the thermal mode is selected by selecting the power efficiency mode (Best power efficiency) of the power supply mode (power mode).

As described above, by repeating the pressing of the hot key, the options of the power supply mode (power mode) of the OS are sequentially selected in a toggle manner, and the options of the thermal mode are sequentially selected in a toggle manner through the selections.

Moreover, mode icons M10 respectively corresponding to the performance mode (Performance), the balance mode (Balanced), and the power-saving mode (Eco) included in the thermal mode as options are set as pieces of display information, and the mode icon M10 corresponding to the selected mode is displayed on the display unit 14.

However, any of specific applications or tools that are executed on Windows (registered trademark), for example, may dogmatically change a power plan for Windows (registered trademark). The power plan includes plans for hardware and system settings of managing how power is used, and a power plan (e.g., Balanced) of keeping balance between the performance and power consumption among the plans is set as a standard. In the standard setting, the change in the power supply mode (power mode) as described above can be made, but, if the mode is changed from the standard power plan, the power supply mode may not be changed depending on the changed content of the hardware and system settings.

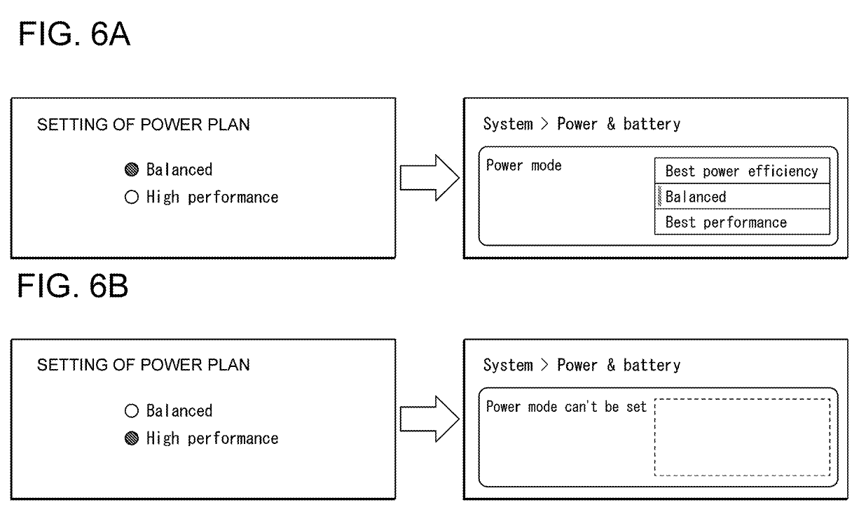

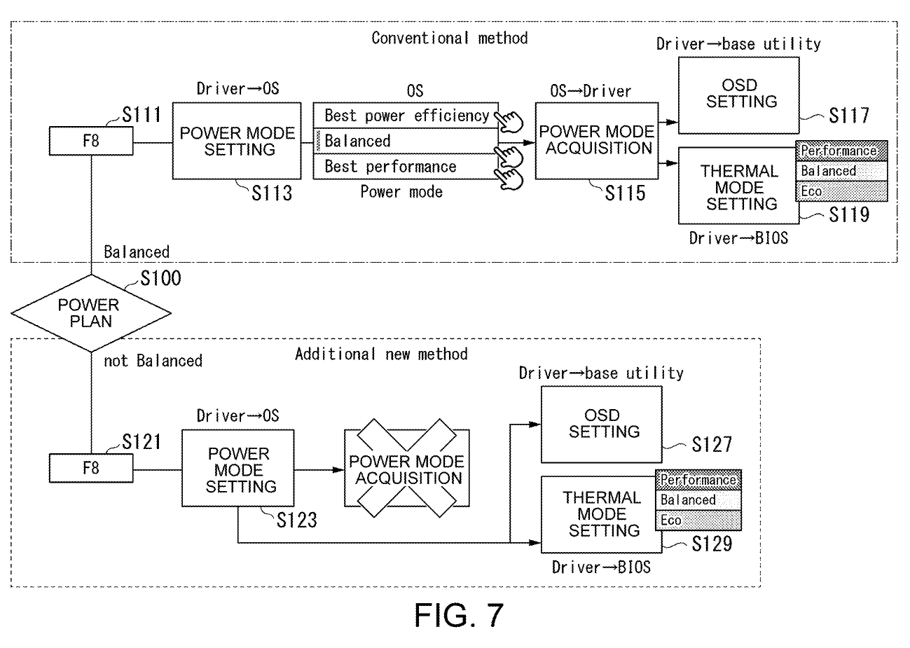

FIGS. 6A-6B are diagrams illustrating an example of a relationship between the power plan and the power supply mode (power mode) according to one or more embodiments. As illustrated in FIG. 6A, when the power plan is set to the standard "Balanced", a list of options is displayed on a setting screen of the power supply mode (power mode) to be selectable. On the other hand, as illustrated in FIG. 6B, when the power plan is set to an item other than "Balanced", the list of the options is not displayed not to be selectable. In detail, even if the power plan is the item other than "Balanced", the power supply mode (power mode) may be selected depending on the hardware and system settings. However, because there is no guarantee that the power supply mode (power mode) can be selected in the power plan other than "Balanced" and the detailed settings are determined by the OS, it is hard to understand the selection from the outside of the OS.

In this regard, as an example, the information processing apparatus 10 according to one or more embodiments makes the selection process of the thermal mode different between when the power plan is set to "Balanced" (i.e., when the power supply mode (power mode) can be selected) and when the power plan is set to the item other than "Balanced".

### Selection process of Thermal mode

FIG. 7 is a diagram illustrating an example of a flow of the selection process of the thermal mode according to one or more embodiments. Operations of the selection process of the thermal mode in the information processing apparatus 10 will be described with reference to FIG. 7.

(Step S100) The second processing module 112 acquires setting information of the OS from the first processing module 111, and determines whether a power plan for the OS is set to "Balanced" or an item other than "Balanced". When it is determined that the power plan is set to "Balanced", the second processing module 112 proceeds to Step S111, and performs a selection process (conventional method) of the thermal mode that uses the selection of the power supply mode (power mode) of the OS. On the other hand, when it is determined that the power plan is set to the item other than "Balanced", the second processing module 112 proceeds to Step S121, and performs a selection process (new method) of the thermal mode that does not use the selection of the power supply mode (power mode) of the OS.

First, the selection process (conventional method) of the thermal mode when the power plan is set to "Balanced" will be described.

(Step S111) The second processing module 112 proceeds to Step S113 when a hot key (e.g., fn+F8 key) is pressed.

(Step S113) The second processing module 112 transmits instruction information of selecting an option of the power supply mode (power mode) to the first processing module 111 in response to the pressing of the hot key. In other words, the second processing module performs settings of the power supply mode (power mode) for the OS through the thermal control driver in response to the pressing of the hot key. Then, the second processing module proceeds to Step S115.

(Step S115) The second processing module 112 acquires the option of the power supply mode (power mode) selected by the first processing module 111. In other words, the thermal control driver acquires the selected option of the power supply mode (power mode) from the OS. Then, the second processing module proceeds to Step S117 and Step S119.

(Step S117) The second processing module 112 selects an option of the thermal mode associated with the option of the power supply mode (power mode) acquired in Step S115, and instructs the display unit 14 to display the mode icon M10 corresponding to the selected option of the thermal mode as an on-screen display (OSD) setting. For example, the second processing module calls a utility (base utility) of displaying the OSD from the thermal control driver, and sets the mode icon M10 corresponding to the selected option of the thermal mode on the OSD.

(Step S119) The second processing module 112 selects an option of the thermal mode associated with the option of the power supply mode (power mode) acquired in Step S115, and performs a setting for an operation of the information processing apparatus 10 based on the selected option of the thermal mode. For example, the second processing module performs settings of the thermal mode for the BIOS, such as the limitation of an operating frequency of the CPU 11, a screen brightness of the display unit 14, and a rotation speed of the heat dissipation fan 35, through the thermal control driver.

Note that one of Step S117 and Step S119 may be processed in first or the steps may be simultaneously processed.

Next, the selection process (new method) of the thermal mode when the power plan is set to the item (not Balanced) other than "Balanced" will be described.

(Step S121) The second processing module 112 proceeds to Step S123 when the hot key (e.g., fn+F8 key) is pressed.

(Step S123) The second processing module 112 transmits instruction information of selecting an option of the power supply mode (power mode) to the first processing module 111 in response to the pressing of the hot key. In this regard, however, the second processing module 112 merely transmits the instruction information to the first processing module 111, and thus does not acquire the option of the power supply mode (power mode) from the first processing module 111 because the power supply mode (power mode) cannot be selected in the first processing module 111. The second processing module 112 directly selects an option of the thermal mode in response to the pressing of the hot key. In other words, when the hot key is pressed, the second processing module 112 performs the selection process of the thermal mode regardless of the process of selecting the power supply mode (power mode). Then, the second processing module proceeds to Step S127 and Step S129.

(Step S127) The second processing module 112 instructs the display unit 14 to display the mode icon M10 corresponding to the option of the thermal mode selected in Step S123 as the OSD setting. For example, the second processing module calls a utility (base utility) of displaying the OSD from the thermal control driver, and sets the mode icon M10 corresponding to the selected option of the thermal mode on the OSD.

(Step S129) The second processing module 112 performs a setting for an operation of the information processing apparatus 10 based on the option of the thermal mode selected in Step S123. For example, the second processing module performs settings of the thermal mode for the BIOS, such as the limitation of an operating frequency of the CPU 11, a screen brightness of the display unit 14, and a rotation speed of the heat dissipation fan 35, through the thermal control driver.

Note that one of Step S127 and Step S129 may be processed in first or the steps may be simultaneously processed.

### Summary of Embodiments

As described above, the information processing apparatus 10 according to one or more embodiments includes a processor (e.g., the CPU 11) that executes a first process by the OS and a second process by a program (e.g., the thermal control driver) that is executed on the OS. The information processing apparatus 10 performs a first setting control process of selectably controlling an option (e.g., an option of the power supply mode (power mode)) of a first setting group including options of a plurality of first settings as settings of the OS in the first process. Moreover, the information processing apparatus 10 performs a second setting control process of selectably controlling an option (e.g., an option of the thermal mode) of a second setting group including as options second settings respectively associated with the plurality of options (first settings) included in the power supply mode (power mode) in the second process. Moreover, the information processing apparatus 10 performs an operation setting process of performing a setting for an operation of the information processing apparatus 10 based on the option (second setting) of the thermal mode selected by the second setting control process in the second process.

Then, when the first setting control process (the selection of the power supply mode (power mode)) is valid, in the second setting control process (the selection of the thermal mode), the information processing apparatus 10 acquires an option (first setting) selected from among the options of the power supply mode (power mode) by the first setting control process in response to input of a specific operation (e.g., pressing of a hot key), and selects an option (second setting) of the thermal mode associated with the acquired option (first setting) from among the options of the thermal mode. On the other hand, when the first setting control process (the selection of the power supply mode (power mode)) is invalid, in the second setting control process, the information processing apparatus 10 selects an option (second setting) of the thermal mode from among the options of the thermal mode in response to the input of the specific operation (e.g., the pressing of the hot key).

As a result, when performing the second setting (e.g., the setting of the thermal mode) in the second process by the program that is executed on the OS by using the first setting (e.g., the setting of the power supply mode) of the OS, the information processing apparatus 10 can perform the second setting (e.g., the setting of the thermal mode) in response to the input of the specific operation (e.g., the pressing of the hot key) even when the first setting (e.g., the setting of the power supply mode) is valid or invalid so as to be able to improve the operability.

Moreover, the information processing apparatus 10 instructs, in the second process, the display unit 14 to display the mode icon M10 (e.g., a piece of display information) corresponding to the option (second setting) of the thermal mode selected by the second setting control process.

As a result, when performing the second setting (e.g., the setting of the thermal mode) in response to the input of the specific operation (e.g., the pressing of the hot key), the information processing apparatus 10 can cause the user to easily check what is selected at every operation.

For example, the options (example of the first settings included in the first setting group) of the power supply mode (power mode) and the options (example of the second settings included in the second setting group) of the thermal mode include settings that affect the performance and power consumption.

As a result, the information processing apparatus 10 can improve the operability when the user selects settings that affect the performance and power consumption.

Moreover, for example, the options (example of the second settings included in the second setting group) of the thermal mode include a setting that affects a temperature rise inside a chassis of the information processing apparatus 10.

As a result, the information processing apparatus 10 can improve the operability when the user selects the settings that affect the performance, the power consumption, and the temperature rise inside the chassis.

Moreover, the information processing apparatus 10 further includes the heat dissipation fan 35 configured to dissipate heat inside the chassis to the outside, and the options (example of the second settings included in the second setting group) of the thermal mode include a setting for the control of the heat dissipation fan 35.

As a result, the information processing apparatus 10 can improve the operability when the user selects settings that consider performance, power consumption, sound (noise) generated by the rotation of the heat dissipation fan 35, and the like.

Moreover, whether the first setting control process (the selection of the power supply mode (power mode)) is valid or invalid is determined based on selection of a setting different from selection of the power supply mode (power mode) among the settings of the OS.

As a result, the information processing apparatus 10 can perform the setting of the thermal mode without using the power supply mode (power mode) even if the setting of the power supply mode (power mode) of the OS is invalid by changing, for example, the other setting of the OS (e.g., uniquely changing the other setting by another application or tool) so as to be able to improve the operability.

For example, whether the first setting control process (the selection of the power supply mode (power mode)) is valid or invalid is determined based on selection of the power plan (example of hardware and system settings related to power) among the settings of the OS.

As a result, the information processing apparatus 10 can perform the setting of the thermal mode without using the power supply mode (power mode) even if the setting of the power supply mode (power mode) of the OS is invalid by changing, for example, the setting of the power plan for the OS (e.g., uniquely changing the setting by the other application or tool) so as to be able to improve the operability.

Moreover, the specific operation includes a preset operation on the hot key (e.g., the fn+F8 key), for example.

As a result, because the setting of the thermal mode can be performed by the operation on the hot key, the information processing apparatus 10 can improve the operability compared to the case where multiple (e.g., four) operations are required.

Note that the specific operation of selecting the thermal mode is not limited to the hot key (e.g., the fn+F8 key). For example, the specific operation may be an operation on a hot key that uses a function key other than the F8 key, or may be an operation on an icon that is displayed on the display unit 14 by a graphical user interface (GUI) provided by a specific application having a function of selecting the thermal mode.

Moreover, the information processing apparatus 10 according to one or more embodiments switches, in the second setting control process (the selection of the thermal mode), between a first selection process of acquiring an option (first setting) selected from among the options of the power supply mode (power mode) by the first setting control process in response to input of a specific operation (e.g., pressing of the hot key) and selecting an option (second setting) of the thermal mode associated with the acquired option (first setting) from among the options of the thermal mode and a second selection process of selecting an option (second setting) of the thermal mode from among the options of the thermal mode in response to the input of the specific operation (e.g., the pressing of the hot key), in accordance with a specific setting (e.g., setting of the power plan) different from the setting of the power supply mode (power mode) among the settings of the OS.

As a result, when performing the second setting (e.g., the setting of the thermal mode) in the second process by the program that is executed on the OS, the information processing apparatus 10 can switch between the process that uses the first setting (e.g., the setting of the power supply mode) of the OS and the process that does not use the first setting, and thus can perform the second setting (e.g., the setting of the thermal mode) in response to the input of the specific operation (e.g., the pressing of the hot key) even when the first setting (e.g., the setting of the power supply mode) is valid or invalid. Therefore, the information processing apparatus 10 can improve the operability.

Moreover, the control method for the information processing apparatus 10 according to one or more embodiments includes: by a processor (e.g., the CPU 11), performing a first setting control process of selectably controlling an option (e.g., option of the power supply mode (power mode)) of a first setting group including options of a plurality of first settings as settings of the OS in a first process by the OS; performing a second setting control process of selectably controlling an option (e.g., option of the thermal mode) of a second setting group including as options second settings respectively associated with the plurality of options (first settings) included in the power supply mode (power mode) in a second process by a program (e.g., the thermal control driver) that is executed on the OS; performing an operation setting process of performing a setting for an operation of the information processing apparatus 10 based on the option (second setting) of the thermal mode selected by the second setting control process in the second process; when the first setting control process (the selection of the power supply mode (power mode)) is valid, in the second setting control process (the selection of the thermal mode), acquiring an option (first setting) selected from among the options of the power supply mode (power mode) by the first setting control process in response to input of a specific operation (e.g., pressing of the hot key) and selecting an option (second setting) of the thermal mode associated with the acquired option (first setting) from among the options of the thermal mode; and when the first setting control process (the selection of the power supply mode (power mode)) is invalid, in the second setting control process, selecting an option (second setting) of the thermal mode from among the options of the thermal mode in response to the input of the specific operation (e.g., the pressing of the hot key).

As a result, when performing the second setting (e.g., the setting of the thermal mode) in the second process by the program that is executed on the OS by using the first setting (e.g., the setting of the power supply mode) of the OS, the control method for the information processing apparatus 10 can perform the second setting (e.g., the setting of the thermal mode) in response to the input of the specific operation (e.g., the pressing of the hot key) even when the first setting (e.g., the setting of the power supply mode) is valid or invalid so as to be able to improve the operability.

Moreover, the control method for the information processing apparatus 10 according to one or more embodiments includes: by a processor (e.g., the CPU 11), performing a first setting control process of selectably controlling an option (e.g., option of the power supply mode (power mode)) of a first setting group including options of a plurality of first settings as settings of the OS in a first process by the OS; performing a second setting control process of selectably controlling an option (e.g., option of the thermal mode) of a second setting group including as options second settings respectively associated with the plurality of options (first settings) included in the power supply mode (power mode) in a second process by a program (e.g., the thermal control driver) that is executed on the OS; performing an operation setting process of performing a setting for an operation of the information processing apparatus 10 based on the option (second setting) of the thermal mode selected by the second setting control process in the second process; and switching, in the second setting control process (the selection of the thermal mode), between a first selection process of acquiring an option (first setting) selected from among the options of the power supply mode (power mode) by the first setting control process in response to input of a specific operation (e.g., pressing of the hot key) and selecting an option (second setting) of the thermal mode associated with the acquired option (first setting) from among the options of the thermal mode and a second selection process of selecting an option (second setting) of the thermal mode from among the options of the thermal mode in response to the input of the specific operation (e.g., the pressing of the hot key), in accordance with a specific setting (e.g., setting of the power plan) different from the setting of the power supply mode (power mode) among the settings of the OS.

As a result, when performing the second setting (e.g., the setting of the thermal mode) in the second process by the program that is executed on the OS, the control method for the information processing apparatus 10 can switch between the process that uses the first setting (e.g., the setting of the power supply mode) of the OS and the process that does not use the first setting, and thus can perform the second setting (e.g., the setting of the thermal mode) in response to the input of the specific operation (e.g., the pressing of the hot key) even when the first setting (e.g., the setting of the power supply mode) is valid or invalid. Therefore, the control method for the information processing apparatus 10 can improve the operability.

Note that, in one or more embodiments, there has been explained an example in which the case where the power plan is "Balanced", namely, the case where the first setting control process (the selection of the power supply mode (power mode)) is valid performs the selection process (conventional method) of the thermal mode that uses the selection of the power supply mode (power mode) of the OS, and the case where the power plan is the item other than "Balanced" performs the selection process (new method) of the thermal mode that does not use the selection of the power supply mode (power mode) of the OS (see FIG. 7). However, embodiments are not limited to this, and the selection process (new method) of the thermal mode that does not use the selection of the power supply mode (power mode) of the OS may be performed regardless of the setting of the power plan (regardless of whether the selection of the power supply mode (power mode) is valid or invalid).

For example, the information processing apparatus 10 according to one or more embodiments performs a first setting control process of selectably controlling an option (e.g., option of the power supply mode (power mode)) of a first setting group including options of a plurality of first settings as settings of the OS in a first process by the OS. Moreover, the information processing apparatus 10 performs a second setting control process of selectably controlling an option (e.g., option of the thermal mode) of a second setting group including as options second settings respectively associated with the plurality of options (first settings) included in the power supply mode (power mode) in a second process by a program (e.g., the thermal control driver) that is executed on the OS. Moreover, the information processing apparatus 10 performs an operation setting process of performing a setting for an operation of the information processing apparatus 10 based on the option (second setting) of the thermal mode selected by the second setting control process in the second process. Then, the information processing apparatus 10 may select an option of the thermal mode in response to input of a specific operation (e.g., pressing of the hot key) regardless of the first setting control process (the selection of the power supply mode (power mode)) in the second setting control process (the selection of the thermal mode).

As a result, when performing the second setting (e.g., the setting of the thermal mode) in the second process by the program that is executed on the OS, the information processing apparatus 10 can perform the second setting without using the first setting (e.g., the setting of the power supply mode) of the OS, and thus can perform the second setting (e.g., the setting of the thermal mode) in response to the input of the specific operation (e.g., the pressing of the hot key) regardless of whether the first setting (e.g., the setting of the power supply mode) is valid or invalid. Therefore, the information processing apparatus 10 can improve the operability.

Moreover, the control method for the information processing apparatus 10 according to one or more embodiments may include: by a processor (e.g., the CPU 11), performing a first setting control process of selectably controlling an option (e.g., option of the power supply mode (power mode)) of a first setting group including options of a plurality of first settings as settings of the OS in a first process by the OS; performing a second setting control process of selectably controlling an option (e.g., option of the thermal mode) of a second setting group including as options second settings respectively associated with the plurality of options (first settings) included in the power supply mode (power mode) in a second process by a program (e.g., the thermal control driver) that is executed on the OS; performing an operation setting process of performing a setting for an operation of the information processing apparatus 10 based on the option (second setting) of the thermal mode selected by the second setting control process in the second process; and selecting the option of the thermal mode in response to input of a specific operation (e.g., pressing of the hot key) regardless of the first setting control process (the selection of the power supply mode (power mode)) in the second setting control process (the selection of the thermal mode).

As a result, when performing the second setting (e.g., the setting of the thermal mode) in the second process by the program that is executed on the OS, the control method for the information processing apparatus 10 can perform the second setting without using the first setting (e.g., the setting of the power supply mode) of the OS, and thus can perform the second setting (e.g., the setting of the thermal mode) in response to the input of the specific operation (e.g., the pressing of the hot key) regardless of whether the first setting (e.g., the setting of the power supply mode) is valid or invalid. Therefore, the control method for the information processing apparatus 10 can improve the operability.

As described above, although the embodiments of the present invention have been described in detail with reference to the accompanying drawings, the specific configuration is not limited to the above-described embodiments and includes designs etc. that do not depart from the scope of the present invention. For example, the configurations described in the above embodiments can be arbitrarily combined.

In the above embodiments, the power supply mode (power mode) has been explained as an example of the first setting (first setting group) as the setting of the OS and the thermal mode has been explained as an example of the second setting (second setting group) by the thermal control driver, but these settings may be applied to other settings. Moreover, the case where whether the first setting (e.g., the setting of the power supply mode) is valid or invalid is determined based on the selection of the power plan among the settings of the OS has been explained, but a configuration that whether the first setting (e.g., the setting of the power supply mode) is valid or invalid is determined by a setting other than the power plan may be employed.

Note that the information processing apparatus 10 as described above includes therein a computer system. In this case, the above-described processes in the components included in the information processing apparatus 10 may be performed by recording a program for realizing the above- described functions of the components included in the information processing apparatus 10 in a computer-readable recording medium and loading the program recorded in the recording medium into the computer system to execute the program. Herein, "loading the program recorded in the recording medium into the computer system to execute the program" includes installing the program into the computer system. "The computer system" as used herein includes OS and hardware such as peripheral devices. Moreover, "the computer system" may include a plurality of computer apparatuses connected via the network including a communication line such as the Internet, WAN, LAN, and a dedicated line. Moreover, "the computer-readable recording medium" means a portable medium such as, a flexible disk, a magneto-optical disc, a ROM, and a CD-ROM, and a storage device such as a hard disk embedded in the computer system. As described above, the recording medium storing the program may be a non-transitory recording medium such as CD-ROM.

Moreover, the recording medium also includes a recording medium that is accessible from a distribution server and is provided internally or externally to deliver the program. Note that a plurality of programs obtained by dividing the program may be configured to be downloaded at respective different times and then be combined by each component included in the information processing apparatus 10 or the divided programs may be delivered by respective different distribution servers. Furthermore, "the computer- readable recording medium" includes a medium that holds a program in a fixed time, such as a volatile memory (RAM) inside a computer system that becomes a server and a client when the program is transmitted via the network. Moreover, the program may be for realizing some of the above functions. Furthermore, the program may be one realized by combining the above function with a program already recorded in the computer system, a so-called differential file (differential program).

Some or all of the functions included in the information processing apparatus 10 according to the above- described embodiments may be realized by an integrated circuit such as a large scale integration (LSI). Each function may be individually realized as a processor, or some or all of the functions may be integrated as a processor. Moreover, the circuit integration method is not limited to the LSI, and may be realized by a dedicated circuit or a general purpose processor. Moreover, when an integrated circuit technology replacing the LSI appears thanks to advancements in a semiconductor technology, an integrated circuit by the technology may be used.

### Description of Symbols

10 information processing apparatus

101 display chassis

101a display surface

101b top surface

102 apparatus chassis

102akeyboard surface

102b bottom surface

103 hinge mechanism

11 CPU

12 main memory

13 video subsystem

14 display unit

21 chipset

22 BIOS memory

23 storage medium

24 audio system

24 WLAN card

26 USB connector

31 embedded controller

32 keyboard

33 power supply circuit

34 battery

35 heat dissipation fan

36 temperature sensor

37 acceleration sensor

100 control unit

111 first processing module

112 second processing module

What is claimed is:

1. An information processing apparatus comprising:
a processor configured to execute a first process by an operating system (OS) and a second process by a program that is executed on the OS, wherein the processor is configured to perform:
a first setting control process of selectably controlling an option of a first setting group including options of a plurality of first settings as settings of the OS in the first process;
a second setting control process of selectably controlling an option of a second setting group including second settings, as options, respectively associated with each of the plurality of first settings included in the first setting group in the second process; and
an operation setting process of performing a setting for an operation of the information processing apparatus based on a second setting selected by the second setting control process in the second process, and
the processor is configured to:
when the first setting control process is valid, in the second setting control process, acquire a first setting selected from the first setting group by the first setting control process in response to input of a specific operation
and select a second setting associated with the acquired first setting from the second setting group; andwhen the first setting control process is invalid, in the second setting control process, select a second setting from the second setting group in response to the input of the specific operation.

2. The information processing apparatus according to claim 1, wherein the processor is configured to instruct, in the second process, a display unit to display a piece of display information corresponding to the second setting selected by the second setting control process.

3. The information processing apparatus according to claim 1, wherein the first settings included in the first setting group and the second settings included in the second setting group include settings that affect performance and power consumption.

4. The information processing apparatus according to claim 3, wherein the second settings included in the second setting group include a setting that affects a temperature rise inside a chassis of the information processing apparatus.

5. The information processing apparatus according to claim 4, further comprising:
a heat dissipation fan configured to dissipate heat inside the chassis of the information processing apparatus to an outside, wherein the second settings included in the second setting group include a setting for control of the heat dissipation fan.

6. The information processing apparatus according to claim 1, wherein whether the first setting control process is valid or invalid is determined based on selection of a setting different from selection of the first setting included in the first setting group among the settings of the OS.

7. The information processing apparatus according to claim 6, wherein whether the first setting control process is valid or invalid is determined based on selection of hardware and system settings related to power among the settings of the OS.

8. The information processing apparatus according to claim 1, wherein the specific operation includes a preset operation on a hot key.

9. The information processing apparatus according to claim 1, wherein when the first setting control process is invalid, in the second setting control process, the processor selects the second setting directly from the second setting group, without acquiring a first setting selected from the first setting group, in response to the input of the specific operation.

10. An information processing apparatus comprising:
a processor configured to execute a first process by an operating system (OS) and a second process by a program that is executed on the OS, wherein the processor is configured to perform:
a first setting control process of selectably controlling an option of a first setting group including options of a plurality of first settings as settings of the OS in the first process;
a second setting control process of selectably controlling an option of a second setting group including second settings, as options, respectively associated with each of the plurality of first settings included in the first setting group in the second process; and
an operation setting process of performing a setting for an operation of the information processing apparatus
based on a second setting selected by the second setting control process in the second process, andthe processor is configured to switch, in the second setting control process, between a first selection process and a second selection process in accordance with a specific setting different from a first setting among the settings of the OS, the first selection process of acquiring the first setting selected from the first setting group by the first setting control process in response to input of a specific operation and selecting a second setting associated with the acquired first setting from the second setting group, the second selection process of selecting a second setting from the second setting group in response to the input of the specific operation.

11. An information processing apparatus comprising:
a processor configured to execute a first process by an operating system (OS) and a second process by a program that is executed on the OS, wherein the processor is configured to perform:
a first setting control process of selectably controlling an option of a first setting group including options of a plurality of first settings as settings of the OS in the first process;
a second setting control process of selectably
controlling an option of a second setting group including second settings, as options, respectively associated with each of the plurality of first settings included in the first setting group in the second process; andan operation setting process of performing a setting for an operation of the information processing apparatus based on a second setting selected by the second setting control process in the second process, andthe processor is configured to select a second setting from the second setting group in response to input of a specific operation regardless of the first setting control process in the second setting control process.
